(19) United States
(12) Patent Application Publication
(10) Pub. No.: US 2022/0122352 A1
(43) Pub. Date: Apr. 21, 2022

(54) METHOD AND APPARATUS FOR DETECTING GAME PROP IN GAME REGION, DEVICE, AND STORAGE MEDIUM

(71) Applicant: SENSETIME INTERNATIONAL PTE. LTD., Singapore (SG)

(72) Inventors: Wenbin ZHANG, Singapore (SG); Yao Zhang, Singapore (SG); Shuai Zhang, Singapore (SG); Shuai Yi, Singapore (SG)

(21) Appl. No.: 17/563,771

(22) Filed: Dec. 28, 2021

Related U.S. Application Data
(63) Continuation of application No. PCT/IB2021/062171, filed on Dec. 22, 2021.

(30) Foreign Application Priority Data
Dec. 20, 2021 (SG) 10202114098S

(51) Int. Cl. G06V 10/98; G06V 20/40; G06V 10/72; G06V 10/26; G06T 7/73; G07F 17/32

(52) U.S. Cl. CPC G06V 10/98; G06V 20/46; G06V 10/72; G06V 10/267; G07F 17/3241; G07F 17/3293; G07F 17/322; G06T 2207/10016; G06T 7/73

(57) ABSTRACT

The embodiments of the application disclose a method for detecting a game prop in a game region, a device, and a storage medium. The method includes that: an image frame sequence collected from a game region at a game prop operating stage is acquired, the image frame sequence including a first preset frame number of game images and the first preset frame number being more than or equal to 2; target detection is performed on each frame of game image in the image frame sequence to obtain a first set of recognition results belonging to the same game prop, each recognition result at least including a confidence of the game prop; and reliability of the first set of recognition results of the game prop is determined based on all confidences in the first set of recognition results of the game prop and a confidence threshold.

### CROSS-REFERENCE TO RELATED APPLICATION

The present disclosure is a continuation application of International Application No. PCT/IB2021/062171, filed on Dec. 22, 2021, which claims priority to Singapore patent application No. 10202114098S, filed with IPOS on Dec. 20, 2021. The contents of International Application No. PCT/IB2021/062171 and Singapore patent application No. 10202114098S are incorporated by reference in their entireties.

### BACKGROUND

In a game place, an event occurring in a game region usually is required to be detected and recognized. Particularly, a game prop in a game process is required to be recognized. At present, a management system deployed in a game place has a relatively high requirement on real-time performance, but a system frame rate is not so high. A game controller operates a game prop too fast, so a confidence of a recognition result of the game prop in a game operating stage is not so high, a tracking Identity (ID) may also change, and furthermore, the accuracy of a related service logic may be affected.

### SUMMARY

Embodiments of the application relates to the field of computer vision technology and provide a method and apparatus for detecting a game prop in a game region, a device, and a storage medium.

The technical solutions of the embodiments of the application are implemented as follows.

According to a first aspect, an embodiment of the application provides a method for detecting a game prop in a game region, which include the following operations.

An image frame sequence collected from a game region at a game prop operating stage is acquired, the image frame sequence includes at least two frames of game images.

Target detection is performed on each frame of game image in the image frame sequence to obtain a first set of recognition results belonging to a same game prop, each recognition result at least includes a confidence of the game prop.

Reliability of the first set of recognition results of the game prop is determined based on all confidences in the first set of recognition results of the game prop and a confidence threshold.

In some embodiments, the number of game image frames in the image frame sequence may be a first preset frame number, the first preset frame number is more than or equal to 2. The operation that the reliability of the first set of recognition results of the game prop is determined based on all confidences in the first set of recognition results of the game prop and the confidence threshold may include the following operations. A number of confidences satisfying the confidence threshold in the first set of recognition results of the game prop is determined. It is determined that the first set of recognition results of the game prop are reliable in a case that the number of the confidences satisfying the confidence threshold is more than or equal to a second preset frame number, the second preset frame number is less than the first preset frame number. And/or, it is determined that that the first set of recognition results of the game prop are unreliable in a case that the number of the confidences satisfying the confidence threshold is less than the second preset frame number.

As such, confidences in acquired recognition results of multiple frames are compared with the threshold to determine whether a set of recognition results of a certain game prop are reliable.

In some embodiments, the method may further include the following operations. A third preset frame number of continuous game images satisfying a preset condition are acquired from the image frame sequence in a case of determining that the first set of recognition results of the game prop are unreliable, the third preset frame number is less than the first preset frame number. A second set of recognition results of the game prop are acquired from the third preset frame number of continuous game images. It is determined that the second set of recognition results of the game prop are reliable.

As such, for the condition that the first set of recognition results do not meet a confidence requirement, the third preset frame number of continuous game images satisfying the preset condition and the corresponding second set of recognition results are acquired, and the second set of recognition results are set to be reliable.

In some embodiments, each recognition result may include a detection box of the game prop. The operation that the third preset frame number of continuous game images satisfying the preset condition are acquired from the image frame sequence in the case of determining that the first set of recognition results of the game prop are unreliable may include the following operations. An Interaction over Union (IoU) between detection boxes of the game prop in every two adjacent frames of game images in the image frame sequence is determined sequentially in the case of determining that the first set of recognition results of the game prop are unreliable. In a case that the IoU between the detection boxes in two adjacent frames of game images satisfies an IoU threshold, any one of the two adjacent frames of game images is determined as a still image frame, the still image frame is a game image representing that the game prop is in a still state. A third preset frame number of continuous game images of which timestamps are later than a timestamp of the still image frame are acquired from the image frame sequence.

As such, the IoU between the detection boxes of the game prop in every two adjacent frames of game images in the image frame sequence is calculated, the still image frame representing that the game prop stops moving in the image frame sequence is determined in combination with the IoU threshold, and the third preset frame number of continuous game images satisfying the preset condition may further be selected. Therefore, in the case of determining that the first set of recognition results do not meet the confidence requirement, the second set of recognition results corresponding to the third preset frame number of continuous game images may be directly set to be reliable.

In some embodiments, the operation that an IoU between the detection boxes of the game prop in every two adjacent frames of game images in the image frame sequence is determined sequentially based on the first set of recognition results of the game prop may include the following operations. A predicted covering score of the game prop in each frame of game image in the image frame sequence is determined based on the first set of recognition results of the game prop, the predicted covering score represents a degree that the game prop is covered in the respective frame of game image. The IoU between the detection boxes of the game prop in every two adjacent frames of game images in the image frame sequence is determined sequentially in a case that the predicted covering score of the game prop in each frame of game image does not satisfy a covering threshold.

As such, the predicted covering score in each frame of game image is compared with the covering threshold, and in a case of determining that the game prop is uncovered in a plurality of continuous frames, the IoU between the detection boxes in adjacent frames is calculated. Therefore, the still frames representing that the game prop stops moving may be subsequently selected based on the IoU between the detection boxes in the adjacent frames.

In some embodiments, the operation that the predicted covering score of the game prop in each frame of game image in the image frame sequence is determined based on the first set of recognition results of the game prop may include the following operations. A region image corresponding to the detection box of the game prop in each frame of game image is determined based on the first set of recognition results of the game prop. Key point detection is performed on the region image to obtain confidences of all key points in the region image. In combination with the confidences of all the key points in the region image, the predicted covering score of the game prop in the respective frame of game image is determined.

As such, according to the confidences of all the key points in each region image, the predicted covering score of the game prop in the respective frame of game image is calculated. Therefore, based on the predicted covering score of each frame, it is convenient to subsequently analyze whether all parts of the game prop in the respective frame of game image are complete.

In some embodiments, a recognition result of a game prop may further includes a tracking ID of the game prop. The operation that the target detection is performed on each frame of game image in the image frame sequence to obtain a first set of recognition results belonging to the same game prop may include the following operations. The target detection is performed on each frame of game image in the image frame sequence to obtain initial recognition results of at least one game prop in all frames of game images. Based on a tracking ID of each game prop, the first set of recognition results of the same game prop associated with the corresponding tracking ID are selected from the initial recognition results of the at least one game prop.

As such, for each game prop, the first set of recognition results of the same game prop are selected from the initial recognition results of all game props in all frames of game images in the image frame sequence.

In some embodiments, the game prop may be a playing card. A recognition result of the playing card may include at least one of: a tracking ID of the playing card, a detection box of the playing card, a suit of the playing card, a denomination of the playing card or a confidence of the playing card.

Therefore, the method for detecting a game prop in a game region in the embodiment of the application is applicable to a condition that playing card recognition is needed.

According to a second aspect, an embodiment of the application provides an apparatus for detecting a game prop in a game region, which include a first acquisition module, a detection module and a first determination module.

The first acquisition module is configured to acquire an image frame sequence collected from a game region at a game prop operating stage, the image frame sequence includes at least two frames of game images.

The detection module is configured to perform target detection on each frame of game image in the image frame sequence to obtain a first set of recognition results belonging to the same game prop, each recognition result at least includes a confidence of the game prop.

The first determination module is configured to determine reliability of the first set of recognition results of the game prop based on all confidences in the first set of recognition results of the game prop and a confidence threshold.

According to a third aspect, an embodiment of the application provides an electronic device, which include a memory for storing a computer program and a processor. The processor is configured to execute the computer program to implement the following operations.

An image frame sequence collected from a game region at a game prop operating stage is acquired, the image frame sequence includes at least two frames of game images.

Target detection is performed on each frame of game image in the image frame sequence to obtain a first set of recognition results belonging to a same game prop, each recognition result at least includes a confidence of the game prop.

Reliability of the first set of recognition results of the game prop is determined based on all confidences in the first set of recognition results of the game prop and a confidence threshold.

According to a fourth aspect, an embodiment of the application provides a non-transitory computer-readable storage medium having stored therein a computer program which, when is executed by a processor to implement the following operations.

An image frame sequence collected from a game region at a game prop operating stage is acquired, the image frame sequence includes at least two frames of game images.

Target detection is performed on each frame of game image in the image frame sequence to obtain a first set of recognition results belonging to a same game prop, each recognition result at least includes a confidence of the game prop.

Reliability of the first set of recognition results of the game prop is determined based on all confidences in the first set of recognition results of the game prop and a confidence threshold.

### BRIEF DESCRIPTION OF THE DRAWINGS

In order to describe the technical solutions in the embodiments of the application more clearly, the drawings required to be used in the descriptions about the embodiments will be simply introduced below. It is apparent that the drawings described below are merely some embodiments of the application. Those of ordinary skill in the art may further obtain other drawings according to these drawings without creative work.

FIG. 1 is a structure diagram of a system for detecting a game prop in a game region according to an embodiment of the application.

FIG. 2 is a flowchart of a method for detecting a game prop in a game region according to an embodiment of the application.

FIG. 3 is a flowchart of a method for detecting a game prop in a game region according to an embodiment of the application.

FIG. 4 is a flowchart of a method for detecting a game prop in a game region according to an embodiment of the application.

FIG. 5 is a flowchart of a method for detecting a game prop in a game region according to an embodiment of the application.

FIG. 6 is a logic flowchart of a method for detecting a game prop in a game region according to an embodiment of the application.

FIG. 7 is a composition structure diagram of an apparatus for detecting a game prop in a game region according to an embodiment of the application.

FIG. 8 is a schematic diagram of a hardware entity of an electronic device according to an embodiment of the application.

### DETAILED DESCRIPTION

In order to make the purpose, technical solutions and advantages of the embodiments of the application clearer, the technical solutions in the embodiments of the application will be described clearly and completely below in combination with the drawings in the embodiments of the application. It is apparent that the described embodiments are not all but part of embodiments of the application. The following embodiments are used to describe the application rather than limit the scope of the application. All other embodiments obtained by those of ordinary skill in the art based on the embodiments in the application without creative work shall fall within the scope of protection of the application.

“Some embodiments” involved in the following descriptions describes a subset of all possible embodiments. However, it can be understood that “some embodiments” may be the same or different subsets of all the possible embodiments and may be combined without conflicts.

It is to be pointed out that term “first/second/third” involved in the embodiments of the application is only for distinguishing similar objects and does not represent a specific sequence of the objects. It can be understood that “first/second/third” may be interchanged to specific sequences or orders if allowed such that the embodiments of the application described herein may be implemented in sequences except the illustrated or described ones.

Those skilled in the art can understand that, unless otherwise defined, all the terms (including technical terms and scientific terms) used herein have the same meanings as commonly understood by those of ordinary skill in the art the embodiments of the application belong to. It is also to be understood that terms defined in, for example, a general dictionary should be understood to have the same meanings as those in the context of the conventional art and may not be explained as idealized or too formal meanings, unless specifically defined like those here.

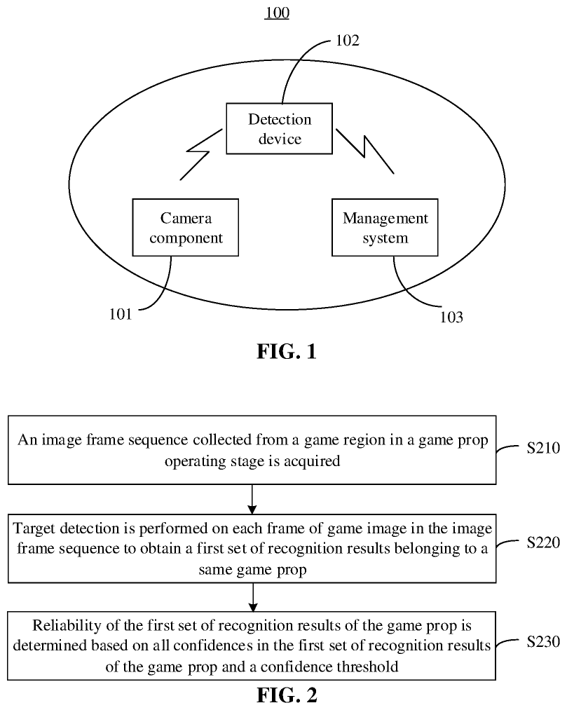

FIG. 1 is a structure diagram of a system for detecting a game prop in a game region according to an embodiment of the application. As shown in FIG. 1, the system 100 may include a camera component 101, a detection device 102, and a management system 103.

In some implementations, the camera component 101 may be a bird's eye camera component. The camera component 101 may include multiple cameras. The multiple cameras may shoot a game region from different angles.

In some implementations, the detection device 102 may correspond to one camera component 101. In some other implementations, the detection device 102 may correspond to multiple camera components 101. For example, the multiple camera components 101 corresponding to the detection device 102 may be multiple camera components 101 configured to shoot game regions in a game place. Alternatively, the multiple camera components 101 corresponding to the detection device 102 may be camera components 101 configured to shoot game regions in a partial region in a game place. The partial region may be a common region, a Very Important Person (VIP) region, etc.

The camera component 101 may be in communication connection with the detection device 102. In some implementations, the camera component 101 may shoot images periodically or aperiodically and send the shot images to the detection device 102. For example, under the condition that the camera component 101 includes multiple cameras, the multiple cameras may shoot images at an interval of a target time length and send the shot images to the detection device 102. The multiple cameras may shoot images at the same time or at different time. In some other implementations, the camera component 101 may shoot a video and send the video to the detection device 102. For example, under the condition that the camera component 101 includes multiple cameras, the multiple cameras may send shot videos to the detection device 102 respectively such that the detection device 102 extracts images to be detected from the videos. In the embodiment of the application, the image may be any one or more of the following game images.

In some implementations, the camera component may continuously shoot images, thereby continuously sending the shot images to the detection device 102. In some other implementations, the camera component may be triggered by a target to start shooting images. For example, the camera component may start shooting images responsive to an instruction of starting operating a game prop.

The detection device 102 may be in communication connection with the management system 103. Under the condition that the detection device 102 determines that an action of a game controller or a player is improper, in order to reduce the loss of the game place or players, the detection device 102 may send alert information to the management system 103 such that the management system 103 may give an alert corresponding to the alert information. Therefore, the condition that improper actions of the game controller or players cause the loss of the game place or the players is reduced.

In some implementations, the detection device 102 may include an edge device or an end device. In some implementations, the detection device 102 may be arranged in the game place. In some other implementations, the detection device 102 may be arranged at a cloud. The detection device 102 may be connected with a server, so that the server may correspondingly control the detection device 102, and/or, the detection device 102 may use service provided by the server.

The embodiment of the application is not limited thereto. In the embodiment corresponding to FIG. 1, the camera component 101, detection device 102 and management system 103 that are presented are independent respectively. However, in another embodiment, the camera component 101 and the detection device 102 may integrated, or, the detection device 102 and the management system 103 may be integrated.

FIG. 2 is a flowchart of a method for detecting a game prop in a game region according to an embodiment of the application. As shown in FIG. 2, the method is applied to the detection device 102. The method at least includes the following operations.

In S210, an image frame sequence collected from a game region at a game prop operating stage is acquired.

Here, the image frame sequence includes at least two frames of game images.

A game in the game region may be a card game such as Baccarat, or a non-card game. Multiple sub-regions may be set in the game region to place game props, game currencies, game signs and the like respectively. In a card game, the game region may be a game table, and the game prop may be a playing card. In a non-card game, the game region may be a game interaction interface, and the game prop may be another prop configured to represent a game process and a result. No limits are made thereto in the embodiment of the application.

It is to be noted that a camera component arranged at different positions of the game region may be used to shoot a real-time video of the game region and send the shot video to an end device. Therefore, the end device may perform extraction on the received video and further perform sampling based on an extracted video sequence of the game region when the game prop stage is entered to obtain at least two frames of game image of the game as an image frame sequence to be detected.

In S220, target detection is performed on each frame of game image in the image frame sequence to obtain a first set of recognition results belonging to the same game prop.

Here, each recognition result at least includes a confidence of the game prop.

For a specific game prop, target detection is performed on each frame of game image in the image frame sequence to obtain recognition results of all frames. The first set of recognition results belonging to the same game prop refer to a combination of recognition results of tracking and recognizing a specific game prop in all frames in the image frame sequence.

In some implementations, the recognition result of the game prop may further include a detection box, class, tracking ID and the like of the game prop. The tracking ID is configured to track the same game prop in two adjacent frames of game images. In some other implementations, under the condition that the game prop is a playing card, the recognition result of the game prop may further include a suit of the playing card, a denomination of the playing card, etc.

The confidence is also called reliability or a confidence level or confidence coefficient. That is, a conclusion obtained by estimating an overall parameter via sampling is always variable because of the randomness of samples. Therefore, a probability statement method is used, i.e., an interval estimation method in mathematical statistics. That is, a corresponding probability that an error between an estimated value and an overall parameter is within a certain allowed range is calculated. The corresponding probability is called the confidence.

It is to be noted that, in the embodiment of the application, at least one camera is provided to acquire images, i.e., game images, during a game process performed in the game region, and the acquired images are converted into computer information and transmitted to the end device for further analysis. A parsing layer and a service layer are configured in the end device. The parsing layer includes multiple algorithm models, such as an object detection algorithm, a recognition algorithm and an association algorithm, which are used to perform target detection on a video sequence acquired by a specific camera (arranged above the game region) to obtain detection and recognition results of each game prop in all frames of game images. The service layer acquires the recognition results of all the game props from the parsing layer and performs a service logic process to determine a set of recognition results belonging to the same game prop in multiple frames of game images.

For example, in an intelligent game region analysis system of a game place, a parsing layer of an end device acquires and processes an image frame sequence to be detected frame by frame to obtain a recognition result Aᵢ of a game prop A, a recognition result Bᵢ of a game prop B and a recognition result Cᵢ of a game prop C in each frame of game image. A set of recognition results belonging to the game prop A in all frames in the image frame sequence are determined to be {A₁, A₂, A₃, A_{N-1}, A_{N}} according to a tracking ID of the game prop A. Herein, Aᵢ represents a recognition result of the game prop A in an ith frame, a value of i ranges from 1 to N, and N is the frame number of game images in the image frame sequence.

In S230, reliability of the first set of recognition results of the game prop is determined based on all confidences in the first set of recognition results of the game prop and a confidence threshold.

Here, the confidence threshold is preset based on an environment where the game region is located and priori experiences.

During implementation, each confidence in the first set of recognition results of the game prop is sequentially compared with the confidence threshold at first to determine the number or percentage of the confidences satisfying the confidence threshold in the first set of recognition results. Then, the reliability of the first set of recognition results of the game prop is determined based on the determination result.

In some implementations, it is determined that the first set of recognition results of the game prop are reliable under the condition that the number of the confidences satisfying the confidence threshold in the first set of recognition results of the game prop is greater than a specific value or the percentage of the number of the confidences to a first preset frame number is greater than a specific threshold. In some other implementations, it is determined that the first set of recognition results of the game prop are unreliable under the condition that the number of the confidences satisfying the confidence threshold in the first set of recognition results of the game prop is less than the specific value or the percentage of the number of the confidences to the first preset frame number is less than the specific threshold.

It is to be noted that a reliability variable associated with the first set of recognition results of the game prop is set to a reliable state when it is determined that the first set of recognition results of the game prop are reliable. Therefore, based on a value of the reliability variable, an upper-layer service directly acquires the first set of recognition results of the game prop for service logic processing.

In the embodiment of the application, the image frame sequence collected from the game region at the game prop operating stage is acquired at first. Then, target detection is performed on each frame of game image in the image frame sequence to obtain the first set of recognition results belonging to the same game prop. Finally, the reliability of the first set of recognition results of the game prop is determined based on all confidences in the first set of recognition results of the game prop and the confidence threshold. As such, for the same game prop, confidences in recognition results of multiple frames of game images are compared with a confidence threshold to determine whether the first set of recognition results of the game prop are reliable to ensure that an upper-layer service may acquire more accurate recognition results for logic processing.

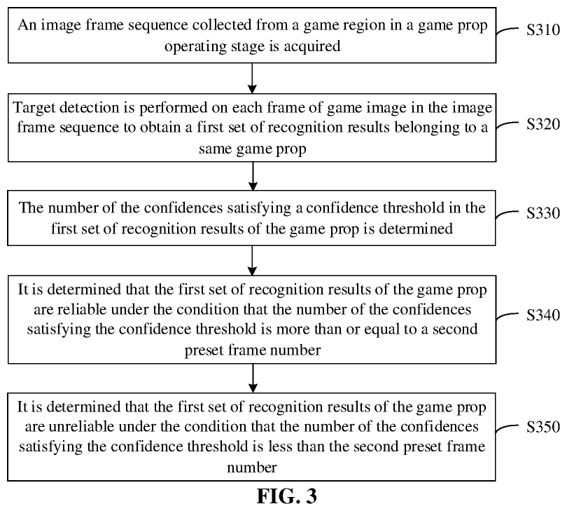

FIG. 3 is a flowchart of a method for detecting a game prop in a game region according to an embodiment of the application. As shown in FIG. 3, the method at least includes the following operations.

In S310, an image frame sequence collected from a game region at a game prop operating stage is acquired.

Here, the image frame sequence includes at least two frames of game images. In some implementations, the number of frames of game images in the image frame sequence is a first preset frame number. The first preset frame number is more than or equal to 2.

In S320, target detection is performed on each frame of game image in the image frame sequence to obtain a first set of recognition results belonging to the same game prop.

Here, each recognition result at least includes a confidence of the game prop. The first set of recognition results of the same game prop include a corresponding set of confidences.

In S330, the number of the confidences satisfying a confidence threshold in the first set of recognition results of the game prop is determined.

Here, the confidence threshold is a priori value. For example, it is set that the image frame sequence includes eight frames of game images and confidences in a first set of recognition results of a game prop A are sequentially {0.6, 0.7, 0.75, 0.7, 0.8}. In such case, if the confidence threshold is set to 0.7, the number of the confidences more than or equal to 0.7 in the first set of recognition results is 4.

In S340, it is determined that the first set of recognition results of the game prop are reliable under the condition that the number of the confidences satisfying the confidence threshold is more than or equal to a second preset frame number.

Here, the second preset frame number is less than the first preset frame number.

The confidences satisfying the confidence threshold in the first set of recognition results of the same game prop are counted, and the number of the confidences satisfying the confidence threshold is compared with the second preset frame number to obtain a result indicating whether the first set of recognition results of the game prop are reliable.

Still taking the example in S330 as an example, the first preset frame number is 5, and the second preset frame number is set to 4. In such case, it may be determined that the first set of recognition results of the game prop A are reliable in combination with that the number of the confidences more than or equal to 0.7 in the first set of recognition results is 4.

In S350, it is determined that the first set of recognition results of the game prop are unreliable under the condition that the number of the confidences satisfying the confidence threshold is less than the second preset frame number.

Similarly, it is set that the first preset frame number is 5, the second preset frame number is 4 and confidences in a first set of recognition results of a game prop A are sequentially {0.6, 0.7, 0.75, 0.7, 0.8}. In such case, if the confidence threshold is set to 0.8, the number of confidences more than or equal to 0.8 in the first set of recognition results is 1, which is less than or equal to the second preset frame number. Therefore, it is determined that the first set of recognition results of the game prop are unreliable.

In the embodiment of the application, confidences in acquired recognition results of multiple frames are compared with the threshold to determine whether a set of recognition results of a certain game prop are reliable. Therefore, corresponding recognition results are more reliable for an upper-layer service.

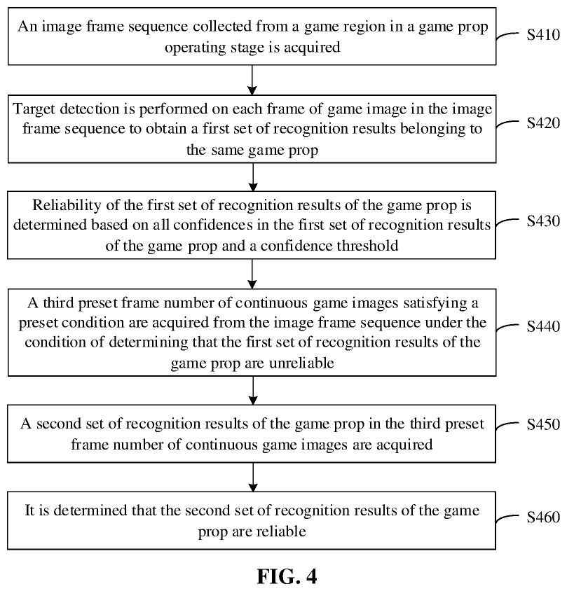

FIG. 4 is a flowchart of a method for detecting a game prop in a game region according to an embodiment of the application. As shown in FIG. 4, the method at least includes the following operations.

In S410, an image frame sequence collected from a game region at a game prop operating stage is acquired.

Here, the image frame sequence includes at least two frames of game images.

In S420, target detection is performed on each frame of game image in the image frame sequence to obtain a first set of recognition results belonging to the same game prop.

Here, each recognition result at least includes a confidence of the game prop.

In some implementations, target detection is performed on each frame of game image in the image frame sequence to obtain initial recognition results of at least one game prop in all frames of game images. Based on a tracking ID of each game prop, the first set of recognition results of the same game prop associated with the tracking ID are selected from the initial recognition results of the at least one game prop.

As such, for each game prop, the first set of recognition results of the same game prop are selected from the initial recognition results of all such game props in all frames of game images in the image frame sequence. Therefore, confidence threshold comparison may be subsequently performed based on the recognition results of the game prop in multiple frames conveniently, so that the recognition results are more reliable.

In S430, reliability of the first set of recognition results of the game prop is determined based on all confidences in the first set of recognition results of the game prop and a confidence threshold.

Here, the confidence threshold is preset based on an environment where the game region is located and priori experiences.

In S440, a third preset frame number of continuous game images satisfying a preset condition are acquired from the image frame sequence under the condition of determining that the first set of recognition results of the game prop are unreliable.

Here, the third preset frame number is less than the first preset frame number. The third preset frame number may be the same as or different from the second preset frame number.

The preset condition represents that recognition results of the game prop in the third preset frame number of continuous game images are stable and reliable. In some implementations, the preset condition may be that a specific game prop is in a still state in a third preset frame number of continuous game images. In some other implementations, the preset condition may also be that a specific game prop is uncovered and at the same position in a third preset frame number of continuous game images.

For example, the image frame sequence includes M frames of game images, and N frames of continuous game images in which the game prop is in a still state are selected from the M frames of game images. M is greater than N.

In S450, a second set of recognition results of the game prop in the third preset frame number of continuous game images are acquired.

Here, the third preset frame number of continuous game images are processed at first frame by frame to obtain the initial recognition results of all game props in all frames of game images. Then, a second set of recognition results of a specific game prop are selected based on a tracking ID of the game prop.

In S460, it is determined that the second set of recognition results of the game prop are reliable.

Here, a reliability variable associated with the second set of recognition results of the game prop may be set to a reliable state. Therefore, based on a value of the reliability variable, an upper-layer service directly acquires the second set of recognition results of the game prop for service logic processing.

In the embodiment of the application, for the condition that the first set of recognition results do not meet a confidence requirement, the third preset frame number of continuous game images satisfying the preset condition and the corresponding second set of recognition results are acquired, and the second set of recognition results are set to be reliable. Therefore, the condition that the threshold is unreasonable for environments where some game regions are located may be compensated.

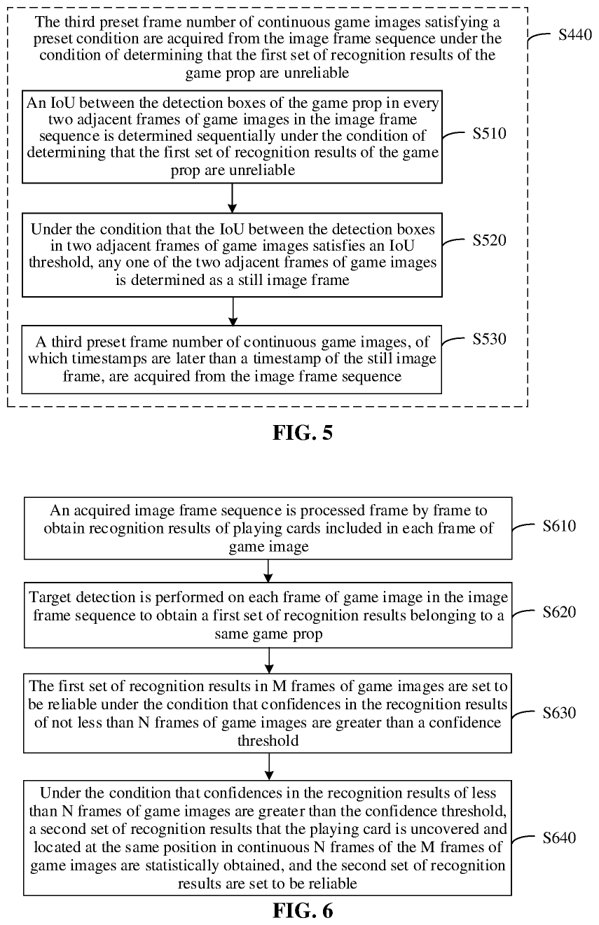

In some possible embodiments, each recognition result includes a detection box of the game prop. FIG. 5 is a flowchart of a method for detecting a game prop in a game region according to an embodiment of the application. As shown in FIG. 5, the operation in S440 that “a third preset frame number of continuous game images satisfying a preset condition are acquired from the image frame sequence under the condition of determining that the first set of recognition results of the game prop are unreliable” includes the following operations.

In S510, an Intersection over Union (IoU) between the detection boxes of the game prop in every two adjacent frames of game images in the image frame sequence is determined sequentially under the condition of determining that the first set of recognition results of the game prop are unreliable.

Here, the IoU between the detection boxes in every two adjacent frames of game images is a result obtained by dividing an overlapping part of detection box regions corresponding to the same game prop respectively in the two frames of game images by a union part of the two detection box regions.

In some implementations, predicted covering scores of the game prop in all frames of game images in the image frame sequence are determined based on the first set of recognition results of the game prop. The IoU between the detection boxes of the game prop in every two adjacent frames of game images in the image frame sequence is determined sequentially under the condition that the predicted covering scores of the game prop in all frames of game images does not satisfy a covering threshold.

The predicted covering score represents a degree that the game prop is covered in the corresponding frame of game image. The covering threshold is a priori value set based on a parameter such as ambient brightness of a game place and classes and sizes of game props.

Since the first set of recognition results of the game prop include the detection boxes of the game prop in each frame of game image in the image frame sequence, key point detection may be performed on an image of a region where the detection box of the game prop is located in each frame of game image, to determine whether the game prop is covered in the respective frame of game image to obtain the predicted covering score of the game prop. Under the condition that the calculated predicted covering scores in adjacent frames of game image do not satisfy the covering threshold, the IoU between the detection boxes of the game prop in every two adjacent frames of game images may further be determined.

As such, the predicted covering score in each frame of game image is compared with the covering threshold, and the IoU between the detection boxes in adjacent frames is calculated under the condition of determining that the game prop in a plurality of continuous frames is uncovered. Therefore, still frames representing that the game prop stops moving may be subsequently selected based on the IoU between the detection boxes in the adjacent frames.

In some implementations, the predicted covering score of the game prop in the respective frame of game image may be determined through the following operations. A region image corresponding to the detection box of the game prop in each frame of game image is determined based on the first set of recognition results of the game prop; Key point detection is performed on the region image to obtain confidences of all key points in the region image; In combination with the confidences of all the key points in the region image, the predicted covering score of the game prop in the respective frame of game image is determined.

Here, a region corresponding to the detection box of the game prop in each frame of game image may be segmented by an image segmentation algorithm in a related art to obtain each region image. Meanwhile, a coordinate and confidence of each key point on the game prop in each region image are obtained by a key point detection algorithm in the related art.

As such, according to the confidences of all the key points in each region image, the predicted covering score of the game prop in the respective frame of game image is calculated. Therefore, based on the predicted covering score of each frame, it is convenient to subsequently analyze whether all parts of the game prop in the respective frame of game image are complete.

In S520, under the condition that the IoU between the detection boxes in two adjacent frames of game images satisfies an IoU threshold, any one of the two adjacent frames of game images is determined as a still image frame.

Here, the IoU threshold is a priori value. If the IoU between the detection boxes in the two adjacent frames of game images satisfies the IoU threshold, it indicates that the game prop is at the same position in the two adjacent frames.

The still image frame is a game image representing that the game prop is in a still state. That is, the game prop stops moving from the still image frame. Therefore, a detection tracking and recognition result obtained after target detection is performed on the still image frame is more stable.

For example, it is set that the IoU threshold is 0.9 and detection boxes of a game prop A in a seventh frame of game image and eighth frame of game image in the image frame sequence are Dec7 and Dec8 respectively. An IoU between the detection boxes Dec7 and Dec8 is calculated to be 0.95, which satisfies the IoU threshold. Therefore, the seventh frame of game image or eighth frame of game image may be set as a still image frame.

It is to be noted that, in the embodiment of the application, under the condition of determining that the first set of recognition results of the game prop are unreliable, the method of acquiring the second set of recognition results after the game prop stops moving is higher in fault tolerance and the condition that setting a unified threshold is unreasonable because of environmental changes in some game places may be compensated.

In S530, a third preset frame number of continuous game images of which timestamps are later than the timestamp of the still image frame are acquired from the image frame sequence.

Here, the game prop in all game images after the still image frame in the image frame sequence may be regarded as being in a still state. A plurality of continuous frames may be directly extracted as a third preset frame number of continuous game images satisfying a preset condition.

In the embodiment of the application, the IoU between the detection boxes of the game prop in every two adjacent frames of game images in the image frame sequence is calculated, the still image frame representing that the game prop stops moving in the image frame sequence is determined in combination with the IoU threshold, and the third preset frame number of continuous game images satisfying the preset condition may further be selected. Therefore, under the condition of determining that the first set of recognition results do not meet a confidence requirement, the second set of recognition results corresponding to the third preset frame number of continuous game images may be directly set to be reliable for an upper-layer service to use.

The method for detecting a game prop in a game region will be described below in combination with a specific embodiment. However, it is to be noted that the specific embodiment is only for describing the application better and does not form improper limits to the application.

The method for detecting a game prop in a game region in the embodiments of the application may be applied to an intelligent game scene. In the intelligent game scene, the game region mentioned in the embodiments of the application may refer to a game table, and the game prop mentioned in the embodiments of the application may include a playing card.

FIG. 6 is a logic flowchart of a method for detecting a game prop in a game region according to an embodiment of the application. As shown in FIG. 6, the method at least includes the following few operations.

In S610, an acquired image frame sequence is processed frame by frame to obtain recognition results of playing cards included in each frame of game image.

Here, playing card detection, tracking and recognition is performed on each frame of game image to obtain recognition results of a plurality of playing cards. The recognition result of each playing card includes a tracking ID, a suit of the playing card, a denomination of the playing card, and a confidence of the playing card. The recognition results of different playing cards are distinguished by the tracking IDs.

In S620, for each playing card, a first set of recognition results in M frames of game images are cached.

Here, the same playing card corresponds to a tracking ID. The recognition results of a certain specific playing card in all frames of game image are combined to obtain a first set of recognition results in the M frames of game images. The first set of recognition results include M confidences.

In S630, the first set of recognition results in the M frames of game images are set to be reliable under the condition that confidences in the recognition results of not less than N frames of game images are greater than a confidence threshold.

Here, the first set of recognition results are set to be reliable if the confidences in the recognition results of N frames in the M frames of game images are greater than the confidence threshold.

In S640, under the condition that confidences in the recognition results of less than N frames of game images are greater than the confidence threshold, a second set of recognition results that the playing card is uncovered and located at the same position in continuous N frames of the M frames of game images are statistically obtained, and the second set of recognition results are set to be reliable.

Here, if the confidences in the recognition results of less than N frames in the M frames of game images are greater than the confidence threshold, after the playing card keeps still in a plurality of frames, the second set of recognition results thereof are acquired, and the second set of recognition results are set to be reliable.

It is to be noted that uncovering in continuous N frames may be reflected by that predicted covering scores in the N frames of game images are less than a covering threshold. Whether detection boxes of the same playing card are at the same position in the N frames of game images may be determined by calculating an IoU between the detection boxes in adjacent frames of game images and combining an IoU threshold.

It is proposed in the embodiment of the application to perform confidence threshold comparison on a cached set of recognition results in the M frames of game images and determine reliability of a set of recognition results in the M frames of game images. Therefore, a set of recognition results finally provided for an upper-layer service are more reliable, and the problem of unreliable recognition results caused by unstable tracking and recognition results of game props during an operation process is solved.

Compared with the related art where recognition results are always unreliable, the embodiment of the application proposes that recognition results after movement are acquired when no recognition results meet the confidence requirement. Compared with directly setting all recognition results to be unreliable, the method of setting the recognition results after movement to be reliable is higher in fault tolerance, and the condition that the threshold is unreasonable for environments of some game places may be compensated.

Based on the above-mentioned embodiments, an embodiment of the application provides an apparatus for detecting a game prop in a game region. Each module of the apparatus and each submodule and unit of each module may be implemented by a processor in an electronic device, or may be implemented by a specific logic circuit of course. In an implementation process, the processor may be a Central Processing Unit (CPU), a Micro Processing Unit (MPU), a Digital Signal Processor (DSP), a Field Programmable Gate Array (FPGA), or the like.

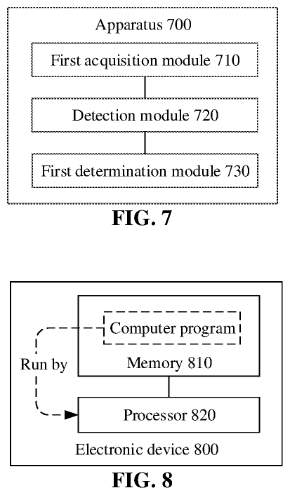

FIG. 7 is a composition structure diagram of an apparatus for detecting a game prop in a game region according to an embodiment of the application. As shown in FIG. 7, the apparatus 700 includes a first acquisition module 710, a detection module 720, and a first determination module 730.

The first acquisition module 710 is configured to acquire an image frame sequence collected from a game region at a game prop operating stage, the image frame sequence includes at least two frames of game images.

The detection module 720 is configured to perform target detection on each frame of game image in the image frame sequence to obtain a first set of recognition results belonging to a same game prop, each recognition result at least includes a confidence of the game prop.

The first determination module 730 is configured to determine reliability of the first set of recognition results of the game prop based on all confidences in the first set of recognition results of the game prop and a confidence threshold.

In some possible embodiments, a number of frames of game images in the image frame sequence is a first preset frame number, the first preset frame number is more than or equal to 2. The first determination module 730 includes a first determination submodule, a second determination submodule, and/or a third determination submodule. The first determination submodule is configured to determine a number of confidences satisfying the confidence threshold in the first set of recognition results of the game prop. The second determination submodule is configured to determine that the first set of recognition results of the game prop are reliable in a case that the number of the confidences satisfying the confidence threshold is more than or equal to a second preset frame number, the second preset frame number is less than the first preset frame number. The third determination submodule is configured to determine that the first set of recognition results of the game prop are unreliable in a case that the number of the confidences satisfying the confidence threshold is less than the second preset frame number.

In some possible embodiments, the apparatus 700 further includes a second acquisition module, a third acquisition module, and a second determination module. The second acquisition module is configured to acquire a third preset frame number of continuous game images satisfying a preset condition from the image frame sequence in a case of determining that the first set of recognition results of the game prop are unreliable, the third preset frame number is less than the first preset frame number. The third acquisition module is configured to acquire a second set of recognition results of the game prop in the third preset frame number of continuous game images. The second determination module is configured to determine that the second set of recognition results of the game prop are reliable.

In some possible embodiments, each recognition result includes a detection box of the game prop. The second acquisition module includes a fourth determination submodule, a fifth determination submodule, and an acquisition submodule. The fourth determination submodule is configured to sequentially determine an IoU between detection boxes of the game prop in every two adjacent frames of game images in the image frame sequence in the case of determining that the first set of recognition results of the game prop are unreliable. The fifth determination submodule is configured to, in the case that the IoU between the detection boxes in two adjacent frames of game images satisfies an IoU threshold, determine any one of the two adjacent frames of game images as a still image frame, the still image frame is a game image representing that the game prop is in a still state. The acquisition submodule is configured to acquire a third preset frame number of continuous game images of which timestamps are later than a timestamp of the still image frame from the image frame sequence.

In some possible embodiments, the fourth determination submodule includes a first determination unit and a second determination unit. The first determination unit is configured to determine a predicted covering score of the game prop in each frame of game image in the image frame sequence based on the first set of recognition results of the game prop, the predicted covering score represents a degree that the game prop is covered in the respective frame of game image. The second determination unit is configured to sequentially determine the IoU between the detection boxes of the game prop in every two adjacent frames of game images in the image frame sequence in the case that the predicted covering score of the game prop in each frame of game image does not satisfy a covering threshold.

In some possible embodiments, the first determination unit includes a first determination subunit, a key point detection subunit, and a second determination subunit. The first determination subunit is configured to determine a region image corresponding to the detection box of the game prop in each frame of game image based on the first set of recognition results of the game prop. The key point detection subunit is configured to perform key point detection on the region image to obtain confidences of all key points in the region image. The second determination subunit is configured to determine, in combination with the confidences of all the key points in the region image, the predicted covering score of the game prop in the respective frame of game image.

In some possible embodiments, a recognition result further includes a tracking ID of the game prop. The detection module 720 includes a detection submodule and a selecting submodule. The detection submodule is configured to perform the target detection on each frame of game image in the image frame sequence to obtain initial recognition results of at least one game prop in all frames of game images. The selecting submodule is configured to select, based on a tracking ID of each game prop, the first set of recognition results of the same game prop associated with the tracking ID from the initial recognition results of the at least one game prop.

In some possible embodiments, the game prop is a playing card. A recognition result of the playing card includes at least one of: a tracking ID of the playing card, a detection box of the playing card, a suit of the playing card, a denomination of the playing card or a confidence of the playing card.

It is to be pointed out that descriptions about the above apparatus embodiment are similar to those about the method embodiment, and beneficial effects similar to those of the method embodiment are achieved. Technical details which are not mentioned in the apparatus embodiment of the application may be understood with reference to the descriptions about the method embodiment of the application.

It is to be noted that, in the embodiments of the application, the method for detecting a game prop in a game region may also be stored in a computer-readable storage medium when implemented in form of a software function module and sold or used as an independent product. Based on such an understanding, the technical solutions of the embodiments of the application substantially or parts making contributions to the related art may be embodied in form of a software product. The computer software product is stored in a storage medium, including a plurality of instructions configured to enable an electronic device (which may be a smart phone with a camera, a tablet computer, etc.) to execute all or part of the method in each embodiment of the application. The storage medium includes various media capable of storing program codes such as a U disk, a mobile hard disk, a Read Only Memory (ROM), a magnetic disk, or an optical disk. Therefore, the embodiments of the application are not limited to any specific hardware and software combination.

Correspondingly, an embodiment of the application provides a computer-readable storage medium having stored therein a computer program which, when being executed by a processor, implement the steps in the method for detecting a game prop in a game region in any above-mentioned embodiment. Correspondingly, there is also provided a chip in an embodiment of the application. The chip includes a programmable logic circuit and/or a program instruction. The chip, when running, is configured to implement the steps in the method for detecting a game prop in a game region in any above-mentioned embodiment. Correspondingly, there is also provided a computer program product in an embodiment of the application. The computer program product comprising instructions which, when being executed by a processor of an electronic device, implement the steps in the method for detecting a game prop in a game region in any above-mentioned embodiment.

Based on the same technical concept, an embodiment of the application provides an electronic device, which is configured to implement a method for detecting a game prop in a game region in the method embodiments. FIG. 8 is a schematic diagram of a hardware entity of an electronic device according to an embodiment of the application. As shown in FIG. 8, the electronic device 800 includes a memory 810 and a processor 820. The memory 810 stores a computer program capable of running in the processor 820. The processor 820 executes the program to implement the steps in any method for detecting a game prop in a game region in the embodiments of the application.

The memory 810 is configured to store an instruction and application executable for the processor 820, may also cache data (for example, image data, video data, voice communication data, and video communication data) to be processed or having been processed by the processor 820 and each module in the electronic device 400, and may be implemented by a flash or a Random Access Memory (RAM).

The processor 820 executes the program to implement the steps of any above-mentioned method for detecting a game prop in a game region. The processor 820 usually controls overall operations of the electronic device 800.

The processor may be at least one of an Application Specific Integrated Circuit (ASIC), a DSP, a Digital Signal Processing Device (DSPD), a Programmable Logic Device (PLD), an FPGA, a CPU, a controller, a microcontroller, or an MPU. It can be understood that other electronic devices may also be configured to realize functions of the processor, and no specific limits are made in the embodiments of the application.

The computer storage medium/memory may be a memory such as a ROM, a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, an optical disk, or a Compact Disc Read-Only Memory (CD-ROM), or may be any electronic device including one or any combination of the above-mentioned memories, such as a mobile phone, a computer, a tablet device, and a personal digital assistant.

It is to be pointed out here that the above descriptions about the storage medium and device embodiments are similar to those about the method embodiment, and beneficial effects similar to those of the method embodiment are achieved. Technical details which are not mentioned in the storage medium and device embodiments of the application are understood with reference to the descriptions about the method embodiment of the application.

It is to be understood that “one embodiment” and “an embodiment” mentioned in the whole specification mean that specific features, structures or characteristics related to the embodiment is included in at least one embodiment of the application. Therefore, “in one embodiment” or “in an embodiment” mentioned throughout the specification does not always refer to the same embodiment. In addition, these specific features, structures or characteristics may be combined in one or more embodiments freely as appropriate. It is to be understood that, in each embodiment of the application, the magnitude of the sequence number of each process does not mean an execution sequence and the execution sequence of each process should be determined by its function and an internal logic and should not form any limit to an implementation process of the embodiments of the application. The sequence numbers of the embodiments of the application are adopted not to represent superiority-inferiority of the embodiments but only for description.

It is to be noted that terms “include” and “contain” or any other variant thereof is intended to cover nonexclusive inclusions herein, so that a process, method, object or device including a series of elements not only includes those elements but also includes other elements which are not clearly listed or further includes elements intrinsic to the process, the method, the object or the device. Under the condition of no more limitations, an element defined by the statement “including a/an . . . .” does not exclude existence of the same other elements in a process, method, object or device including the element.

In some embodiments provided by the application, it is to be understood that the disclosed device and method may be implemented in another manner. The device embodiment described above is only schematic. For example, the division of the units is only logic function division, and other division manners may be adopted during practical implementation. For example, multiple units or components may be combined or integrated into another system, or some characteristics may be neglected or not executed. In addition, coupling or direct coupling or communication connection between various displayed or discussed components may be indirect coupling or communication connection, implemented through some interfaces, of the device or the units, and may be electrical and mechanical or adopt other forms.

The units described as separate parts may or may not be physically separated. Parts displayed as units may or may not be physical units, and namely may be located in the same place or distributed to multiple network units. Part or all of the units may be selected according to a practical requirement to achieve the purposes of the solutions of the embodiments of the application.

In addition, various function units in each embodiment of the application may be integrated into a processing unit. Alternatively, each unit may serve as an independent unit. Alternatively, two or more than two units may be integrated into a unit. The integrated unit may be implemented in a hardware form or in form of a hardware and software function unit.

Alternatively, the integrated unit of the application may be stored in a computer-readable storage medium when implemented in form of a software function module and sold or used as an independent product. Based on such an understanding, the technical solutions of the embodiments of the application substantially or parts making contributions to the related art may be embodied in form of a software product. The computer software product is stored in a storage medium, including a plurality of instructions configured to enable an automatic test line of a device to execute all or part of the method in each embodiment of the application. The storage medium includes various media capable of storing program codes such as a mobile hard disk, a ROM, a magnetic disk, or an optical disc.

The methods disclosed in some method embodiments provided in the application may be freely combined without conflicts to obtain new method embodiments.

The characteristics disclosed in some method or device embodiments provided in the application may be freely combined without conflicts to obtain new method embodiments or device embodiments.

The above is only the implementation mode of the application and not intended to limit the scope of protection of the application. Any variations or replacements apparent to those skilled in the art within the technical scope disclosed by the application shall fall within the scope of protection of the application. Therefore, the scope of protection of the application shall be subject to the scope of protection of the claims.

1. A method for detecting a game prop in a game region, comprising:
acquiring an image frame sequence collected from a game region at a game prop operating stage, the image frame sequence comprising at least two frames of game images;
performing target detection on each frame of game image in the image frame sequence to obtain a first set of recognition results belonging to a same game prop, each recognition result at least comprising a confidence of the game prop; and
determining reliability of the first set of recognition results of the game prop based on all confidences in the first set of recognition results of the game prop and a confidence threshold.

2. The method of claim 1, wherein a number of frames of game images in the image frame sequence is a first preset frame number, the first preset frame number is more than or equal to 2, and wherein determining the reliability of the first set of recognition results of the game prop based on all confidences in the first set of recognition results of the game prop and the confidence threshold comprises:
determining a number of confidences satisfying the confidence threshold in the first set of recognition results of the game prop;
determining that the first set of recognition results of the game prop are reliable in a case that the number of the confidences satisfying the confidence threshold is more than or equal to a second preset frame number, the second preset frame number is less than the first preset frame number; and
determining that the first set of recognition results of the game prop are unreliable in a case that the number of the confidences satisfying the confidence threshold is less than the second preset frame number.

3. The method of claim 1, further comprising:
acquiring a third preset frame number of continuous game images satisfying a preset condition from the image frame sequence in a case of determining that the first set of recognition results of the game prop are unreliable, the third preset frame number is less than a first preset frame number;
acquiring a second set of recognition results of the game prop in the third preset frame number of continuous game images; and
determining that the second set of recognition results of the game prop are reliable.

4. The method of claim 3, wherein each recognition result comprises a detection box of the game prop, and wherein acquiring the third preset frame number of continuous game images satisfying the preset condition from the image frame sequence in the case of determining that the first set of recognition results of the game prop are unreliable comprises:
sequentially determining an Interaction over Union (IoU) between detection boxes of the game prop in every two adjacent frames of game images in the image frame sequence in the case of determining that the first set of recognition results of the game prop are unreliable,
in a case that the IoU between the detection boxes in two adjacent frames of game images satisfies an IoU threshold, determining any one of the two adjacent frames of game images as a still image frame, the still image frame is a game image representing that the game prop is in a still state, and
acquiring a third preset frame number of continuous game images, of which timestamps are later than a timestamp of the still image frame, from the image frame sequence.

5. The method of claim 4, wherein sequentially determining the IoU between the detection boxes of the game prop in every two adjacent frames of game images in the image frame sequence based on the first set of recognition results of the game prop comprises:
determining a predicted covering score of the game prop in each frame of game image in the image frame sequence based on the first set of recognition results of the game prop, the predicted covering score represents a degree that the game prop is covered in the respective frame of game image; and
sequentially determining the IoU between the detection boxes of the game prop in every two adjacent frames of game images in the image frame sequence in a case that the predicted covering score of the game prop in each frame of game image does not satisfy a covering threshold.

6. The method of claim 5, wherein determining the predicted covering score of the game prop in each frame of game image in the image frame sequence based on the first set of recognition results of the game prop comprises:
determining a region image corresponding to the detection box of the game prop in each frame of game image based on the first set of recognition results of the game prop;
performing key point detection on the region image to obtain confidences of all key points in the region image; and
determining, in combination with the confidences of all the key points in the region image, the predicted covering score of the game prop in the respective frame of game image.

7. The method of claim 1, wherein a recognition result of a game prop further comprises a tracking Identity (ID) of the game prop, and wherein performing the target detection on each frame of game image in the image frame sequence to obtain a first set of recognition results belonging to the same game prop comprises:
performing the target detection on each frame of game image in the image frame sequence to obtain initial recognition results of at least one game prop in all frames of game images, and
selecting, based on a tracking ID of each game prop, the first set of recognition results of the same game prop associated with the tracking ID from the initial recognition results of the at least one game prop.

8. The method of claim 1, wherein the game prop is a playing card; and a recognition result of the playing card comprises at least one of: a tracking ID of the playing card, a detection box of the playing card, a suit of the playing card, a denomination of the playing card or a confidence of the playing card.

9. An electronic device, comprising:
a memory for storing a computer program; and
a processor, wherein the processer is configured to execute the computer program to implement the following operations:
acquiring an image frame sequence collected from a game region at a game prop operating stage, the image frame sequence comprising at least two frames of game images;
performing target detection on each frame of game image in the image frame sequence to obtain a first set of recognition results belonging to a same game prop, each recognition result at least comprising a confidence of the game prop; and
determining reliability of the first set of recognition results of the game prop based on all confidences in the first set of recognition results of the game prop and a confidence threshold.

10. The electronic device of claim 9, wherein a number of frames of game images in the image frame sequence is a first preset frame number, and the first preset frame number is more than or equal to 2, and wherein the processer is further configured to execute the computer program to:
determine a number of confidences satisfying the confidence threshold in the first set of recognition results of the game prop;
determine that the first set of recognition results of the game prop are reliable in a case that the number of the confidences satisfying the confidence threshold is more than or equal to a second preset frame number, the second preset frame number is less than the first preset frame number; and
determine that the first set of recognition results of the game prop are unreliable in a case that the number of the confidences satisfying the confidence threshold is less than the second preset frame number.

11. The electronic device of claim 9, wherein the processer is further configured to execute the computer program to:
acquire a third preset frame number of continuous game images satisfying a preset condition from the image frame sequence in a case of determining that the first set of recognition results of the game prop are unreliable, the third preset frame number is less than a first preset frame number;
acquire a second set of recognition results of the game prop in the third preset frame number of continuous game images; and
determine that the second set of recognition results of the game prop are reliable.

12. The electronic device of claim 11, wherein each recognition result includes a detection box of the game prop, and wherein the processer is further configured to execute the computer program to:
sequentially determine an IoU between detection boxes of the game prop in every two adjacent frames of game images in the image frame sequence in the case of determining that the first set of recognition results of the game prop are unreliable;
in a case that the IoU between the detection boxes in two adjacent frames of game images satisfies an IoU threshold, determine any one of the two adjacent frames of game images as a still image frame, the still image frame is a game image representing that the game prop is in a still state; and
acquire a third preset frame number of continuous game images of which timestamps are later than a timestamp of the still image frame from the image frame sequence.

13. The electronic device of claim 12, wherein the processer is further configured to execute the computer program to:
determine a predicted covering score of the game prop in each frame of game image in the image frame sequence based on the first set of recognition results of the game prop, the predicted covering score represents a degree that the game prop is covered in the respective frame of game image; and
sequentially determine the IoU between the detection boxes of the game prop in every two adjacent frames of game images in the image frame sequence in a case that the predicted covering score of the game prop in each frame of game image does not satisfy a covering threshold.

14. The electronic device of claim 13, wherein the processer is further configured to execute the computer program to:
determine a region image corresponding to the detection box of the game prop in each frame of game image based on the first set of recognition results of the game prop;
perform key point detection on the region image to obtain confidences of all key points in the region image; and
determine, in combination with the confidences of all the key points in the region image, the predicted covering score of the game prop in the respective frame of game image.

15. The electronic device of claim 9, wherein a recognition result of a game prop further comprises a tracking Identity (ID) of the game prop, and wherein the processer is further configured to execute the computer program to:
perform the target detection on each frame of game image in the image frame sequence to obtain initial recognition results of at least one game prop in all frames of game images; and
select, based on a tracking ID of each game prop, the first set of recognition results of the same game prop associated with the tracking ID from the initial recognition results of the at least one game prop.

16. The electronic device of claim 9, wherein the game prop is a playing card, and a recognition result of the playing card comprises at least one of: a tracking ID of the playing card, a detection box of the playing card, a suit of the playing card, a denomination of the playing card or a confidence of the playing card.

17. A non-transitory computer-readable storage medium having stored therein a computer program, which is executed by a processor to implement the following operations:
acquiring an image frame sequence collected from a game region at a game prop operating stage, the image frame sequence comprising at least two frames of game images;
performing target detection on each frame of game image in the image frame sequence to obtain a first set of recognition results belonging to a same game prop, each recognition result at least comprising a confidence of the game prop; and
determining reliability of the first set of recognition results of the game prop based on all confidences in the first set of recognition results of the game prop and a confidence threshold.

18. The non-transitory computer-readable storage medium of claim 17, wherein a number of frames of game images in the image frame sequence is a first preset frame number, the first preset frame number is more than or equal to 2, and wherein the computer program is executed by the processor to:
determine a number of confidences satisfying the confidence threshold in the first set of recognition results of the game prop;
determine that the first set of recognition results of the game prop are reliable in a case that the number of the confidences satisfying the confidence threshold is more than or equal to a second preset frame number, the second preset frame number is less than the first preset frame number; and
determine that the first set of recognition results of the game prop are unreliable in a case that the number of the confidences satisfying the confidence threshold is less than the second preset frame number.

19. The non-transitory computer-readable storage medium of claim 17, wherein the computer program is executed by the processor to:
acquire a third preset frame number of continuous game images satisfying a preset condition from the image frame sequence in a case of determining that the first set of recognition results of the game prop are unreliable, the third preset frame number is less than a first preset frame number;
acquire a second set of recognition results of the game prop in the third preset frame number of continuous game images; and
determine that the second set of recognition results of the game prop are reliable.

20. The non-transitory computer-readable storage medium of claim 19, wherein each recognition result comprises a detection box of the game prop, and wherein the computer program is executed by the processor to:
sequentially determine an Interaction over Union (IoU) between detection boxes of the game prop in every two adjacent frames of game images in the image frame sequence in the case of determining that the first set of recognition results of the game prop are unreliable,
in a case that the IoU between the detection boxes in two adjacent frames of game images satisfies an IoU threshold, determine any one of the two adjacent frames of game images as a still image frame, the still image frame is a game image representing that the game prop is in a still state, and
acquire a third preset frame number of continuous game images, of which timestamps are later than a timestamp of the still image frame, from the image frame sequence.
